(19) United States
(12) Patent Application Publication
(10) Pub. No.: US 2010/0239705 A1
(43) Pub. Date: Sep. 23, 2010

(54) Adapter

(76) Inventors: Ken Jorstad, Alta (NO); Hans Einar Jorstad, Alta (NO); Sten Are Uglebakken, Alta (NO)

Correspondence Address: CHRISTIAN D. ABEL, ONSAGERS AS, POSTBOKS 6963 ST. OLAVS PLASS, OSLO, N-0130, NO

(21) Appl. No.: 12/443,183

(22) PCT Filed: Oct. 4, 2007
(86) PCT No.: PCT/NO07/00348

§ 371 Date: May 11, 2009

(30) Foreign Application Priority Data
Oct. 6, 2006 (NO) 20064542
Aug. 31, 2007 (NO) 20074445

(51) Int. Cl. B29C 47/12; B65D 35/38

(52) U.S. Cl. 425/461; 222/566

(57) ABSTRACT

The present invention relates to an adapter (1) comprising a body (2) with support wings (3), a pressure chamber (4), cleaning wings (5), sealing membrane (9) and a joint former (8). During use the adapter (1) is pulled in direction towards the user and away from the joint former (8), so that the joint former (8) is the last one in contact with the joint. Then the cleaning wings (5) clean the surfaces (21) that have been in contact with the grouting and push excess substance into the pressure chamber (4). The adapter (1) according to the present invention is to get the consumption of the grout down, reduce the amount of work and time, and to create an aestethique joint.

### FIELD OF THE INVENTION

The present invention relates to a device that is utilised in connection with gluing, filling and sealing of joints, for instance between tiles, internal or external corners etc. More specifically, the invention relates to an adapter to remove excess substance from joints, seams, grooves, where this can be grouting, filler, adhesive or similar.

### BACKGROUND OF THE INVENTION

In connection with gluing, filling and sealing of seams or joints it is today most common to use a so-called caulking gun. The caulking gun comprises a piston and ahead of the piston a chamber that can imbibe a cartridge or a container. The cartridge or container contains a material that for instance may be a sealing compound or an adhesive, and is in its one end equipped with a movable ending and in its other end with an outlet tap, to which a nozzle may be fastened. In use the caulking gun will drive the piston against and into the rear of the cartridge, in such a way that the material is driven out of the cartridge through the nozzle. The caulking gun may be driven manually or electrically.

By using the above caulking gun to lay a joint it will often be achieved, especially if the work is performed by a person with little experience, a joint that varies both in thickness and/or width along its longitudinal axis. One therefore does not know if the grouting is laid with correct pressure in the joint, i.e. if it's tight, simultaneous as it aesthetically is not looking good. This will thereby result in a supplementary work on the joint being required.

That the joint is not laid right, may be due to that the caulking gun being relatively large as it will have to fit in the hand of the user, simultaneously as it shall manage to accommodate a cartridge of a certain size, so that one will not have to change the cartridges too often. The caulking gun will also be designed so that it only can be held in one position. This will result in that the laying of joints in narrow or on difficult places is complicated further.

In addition, the design of the nozzle has effect on how the joint will look. A nozzle is usually manufactured from a hollow conical body, where the cone in its smallest part (top part) is closed. In use the nozzle is screwed on the cartridge with the material, and the closed end is then that cut off. In practice one can have an outlet with a desired shape and size, but generally one will cut off too much or too little of the nozzle, so that the joint will not be laid satisfactorily.

With common, traditional nozzles it is difficult or impossible to control the cross section form of the joint. It will sometimes be a desire that the cross section form of the joint can be relatively flat (for instance if a joint between two surfaces in same level is to be sealed), the joint can be rounded or curved (concave or convex by jointing of surfaces that are forming an angle with each other), the joint can be a right-angled triangle etc.

The person that is laying the joint will also, to a considerable extent, influence the result, as an even and correctly laid grouting depends on the feeding rate of the material (amount fed out pr unit of time) and forward speed in the direction of the joint (the speed with which the cartridge nozzle is moved along the joint).

The simplest form for a solution on the above mentioned problems is that one use ones own fingers, where these are dipped in soapy water and is brought along the joint to smooth this out. This is especially the case where one cannot reach with the nozzle because of little space, in a corner etc. The solution will often result in that the excess grouting will end up on clothes, hands etc. and that the joint still will not be laid correctly. Other solutions have specified different special forms of the nozzles, wings for cleaning of the surfaces that are jointed, and membrane that prevents grouting leaking out on the sides of the nozzle etc. The below specified publications are examples of known solutions.

A nozzle for grouting cartridges is known from U.S. Pat. No. 3,559,234. The nozzle is shaped with plane side wings that are arranged in order to follow walls or corners that are to be jointed, so that the joint will have an even and regular cross section. The nozzle has moreover cleaning wings that shall clean the lateral surfaces.

In GB 1.026.463 a nozzle for grouting cartridges is shown, where a membrane is attached to the underside of the nozzle. The membrane will seal between the nozzle and the surfaces that the nozzle is in contact with, in such a way that the grouting will not leak. The flexible membrane will moreover be shaped in order to give the desired cross section form on the joint.

Common for all known solutions is that they are seen to be too expensive, too time-consuming to fix in its position, that they are to complicated in use, that they either supply too much or too little grouting or that they are too ineffective.

### PURPOSE OF THE INVENTION

One object of the present invention will therefore be to provide a device, a so-called adapter that is used in connection with grouting and which forms joints of even and high quality.

One further object of the invention is to provide an adapter that will remove excess grouting and form the laid grout, such that supplementary-work on the grouting will nor be required.

One further object of the present invention is to provide an adapter that is used correctly, without requiring the user to have greater knowledge or experience with grouting work.

Yet another object of the present invention will be to provide an adapter that is economical under usage, as very little of the discharged grout is wasted.

Another object of the invention will be to provide an adapter that can be used either together with a grouting cartridge, or as a separate unit.

One further object of the present invention will be to provide an adapter that through an amount adjusting tube may control the discharging of the grout.

Still another object of the present invention will be to provide an adapter that may be used when laying joint or similar round pipes, on plane surfaces, on surfaces with level difference etc.

Yet another object of the present invention is to provide an adapter which under the laying of the joint is time-saving.

In a first aspect of the invention it is provided an adapter that can fit on ordinary grout cartridges. The adapter is then manufactured with a funnel-shaped nozzle being integrated with a body, on which body one or several support wings are arranged to stabilise the adapter during the grouting. This is achieved by the support wings laying against the surfaces that are to be grouted or pasted and following these. The support wings may with that be manufactured in a material which can have flexible characteristics, as the support wings due to unevenness or the like on the surface should be at least partly flexible. The support wings will preferably also be shaped such that the angle that is formed between them is somewhat larger than the angle between the surfaces that are to be grouted or pasted. For instance, is the angle between two surfaces 90 degrees (a corner that shall be grouted), the angle between the support wings be 95 degrees. This will then give the adapter an additional stabilisation, as the adapter must be pushed in to the surfaces, whereby the support wings because of some elasticity will move and provide a correct positioning of the adapter. The support wings may further be right flat, or they may be curved, bent etc.

On the underside of the adapter, i.e. the side of the adapter that lies turned against the surfaces that are to be grouted, there is arranged a pressure magazine or chamber for supplying of substance. This pressure magazine or chamber is further connected with a thorough aperture, which stretches from the inside of the pressure magazine to the outer surface of the adapter. This thorough aperture is utilised to feed grouting or the like to the pressure magazine or chamber on the inside of the adapter. The pressure magazine or chamber is having a particular intention, which is to build up a pressure inside the adapter, in such a way that the grouting may be laid with right pressure in against the groove, joint, seams etc.

The pressure magazine or chamber will also function as a collector for excess grouting when a joint is laid. This may be achieved for instance, by the pressure magazine or chamber being shaped oblong or circular. Along parts of or whole of the pressure magazine or chamber edge a sealing membrane or a combined sealing and cleaning membrane is arranged. The adapter is in its foremost part, i.e. the part that first is guided in the laying direction of the grouting, shaped with a recess in the form of a funnel or the like, in such a way that excess grouting by movement is picked up and lead in towards the middle of the adapter, where the magazine or chamber is placed. The sealing membrane will with its placing prevent that the grouting will escape out broadwise from the adapter and in this manner lead the excess grouting from the surfaces and the joint(s) or the groove(s) back to the pressure magazine. In an alternative embodiment the combined sealing and cleaning membrane in addition to preventing the grouting leaking out, will also clean the surfaces the adapter is laying against. Here will also, in a corresponding way, the excess grouting will be lead back to the pressure chamber.

The sealing membrane is arranged in a way that it is in level with a joint former. The purpose of the joint former will be to give the laid grouting a desired form, and to exert a pressure against the joint, in such a way that the grouting with the right pressure is pressed into the joint, the groove or the area where it is to be jointed. The joint former may have any form or profile, for instance a V form, 45 degrees form, 90 degrees from, concave, convex etc. The joint former will preferably, when seen in the laying direction of the grout, be situated at the rear edge of the pressure chamber.

The pressure magazine or chamber may further be shaped in a way that the distance between the surfaces and up to the pressure magazine or chamber foremost edge, i.e. the edge first being lead in the laying direction of the grouting when the grout is to be laid, will be larger than the distance between the pressure magazine or chamber rear edge and the surface that is to be joined or pasted, as then here will not be a clearance between these. This will result in that the rear edge of the magazine or chamber thereby will act as a stop edge, in such a way that the excess grout will not escape at the rear edge of the adapter. The stop edge will most appropriately be shaped with a straight transverse to the adapter sharp edge, as the stop edge in this way may be used to “cut” off the grouting when one wishes to end the joining. This stop edge may incidentally also serve the purpose as a joint former.

The pressure magazine or chamber may have any form, for instance circular or rectangular form, or as a combination, as an example curved at the foremost edge and a straight, traverse edge according to the moving direction of the adapter.

The form of the outside of the sealing membrane, i.e. the side that is in contact with the foundation will be important, as a form that will not give a sealing effect will result in the grouting possibly leaking out during the utilisation of the adapter. Here the skilled person will understand that the outer side may be triangle shaped, oval, squared, curved etc.

In an alternative embodiment the recess in the foremost edge of the adapter will moreover be shaped with an amount adjusting tube, where this tube is connected with the pressure magazine or chamber. The amount adjusting tube will by the use of the adapter be utilised to ease or adjust the pressure in the pressure chamber or magazine. Further, one will visually be able to control that it is right amount of grouting or adhesive in the pressure magazine and the joint that is to be filled. Furthermore, grouting will flow out of the pressure magazine or chamber and through the amount adjustment tube if the pressure in the amount adjustment tube becomes too high. The grouting or the adhesive as through the amount adjustment tube will flow out of the pressure magazine or chamber and out in the recess, will due to the direction of propulsion be laid in the joint or the groove and fill this from the underside of the adapter. This laying will seal the pressure magazine or the chamber in such a way that the necessary pressure in this is obtained.

In an alternative embodiment the nozzle with the funnel-shaped body and the adapter are manufactured as separate units. The funnel-shaped body may in this case be the nozzle that will follow along when one is buying a grout cartridge in the store. The adapter will then be shaped with a complementary hole to take up a lower end of the funnel-shaped body and suitable fastening means between them.

The adapter is as a basis designed to be used with an ordinary grout cartridge. However, one can also use the adapter as a separate unit in connection with any joint work.

It may also be imagined that the grout cartridge and the adapter can be connected through a flexible hose with a certain length, as this will give a more flexible solution for more inaccessible and constricted areas. The flexible hose may for instance through suitable means be connected between the grout cartridge and the adapter, for instance when jointing between a wall and a tube, so that the adapter due to the flexible hose can be lead around the whole tube.

In a further embodiment it is for feeding of the grout arranged an adjustment or choke device in connection to the magazine for the excess grouting and control of the feeding of the grouting.

When the adapter may also be used by hand, i.e. as a separate unit, the adapter may be designed with holding means, to ensure that it can be held by hand.

Possible cleaning wings may be placed along the edge of the pressure magazine or also around the support wings on the adapter, inclining towards the magazine and preferably placed in an area around the foremost end of the adapter. The cleaning wings are preferably made of a material that is flexible, but yet so stiff that the desired cleaning of the surfaces is achieved.

The sealing membrane is arranged on the underside of the adapter and round or along these edges.

With the adapter according to the invention one seek to avoid or at least to diminish the disadvantages of the known and existing solutions.

Other advantages and features of the present invention will be apparent from the following particular description, the attached drawings and the following claims.

### BRIEF DESCRIPTION OF THE DRAWINGS

FIG. 1 illustrates an adapter according to a first embodiment of the invention, seen in cross-section, from above and under and also from behind, where the adapter is used in connection with the inside of two plates forming 90 degrees with each other shall be jointed,

FIG. 2 illustrates an adapter according to another embodiment of the invention, seen in cross-section, from above and under and also from behind, where the adapter is used in connection with that a notch, joint or groove between two plates shall be joined,

FIG. 3 illustrates an adapter according to a third embodiment of the invention, seen from above and under and also from behind, where the adapter is used in connection with that an external corner of two plates forming 90 degrees with each other shall be joined,

FIG. 4 illustrates an adapter according to a fourth embodiment of the invention, seen from above and under and also from behind, where the adapter is used in connection with that an edge around a pipe that is forming 90 degrees with a horizontal plate shall be joined,

FIG. 5 illustrates a connection muff for the adapter according to the invention,

FIG. 6 illustrates an alternative design of the adapter,

FIG. 7 illustrates laying of a joint on the inside of two plates forming 90 degrees with each other, when using the adapter according to the invention, and

FIG. 8 illustrates the adapter according to the invention, where the adapter through a flexible hose is connected to a cartridge in a caulking gun.

### DETAILED DESCRIPTION OF THE INVENTION

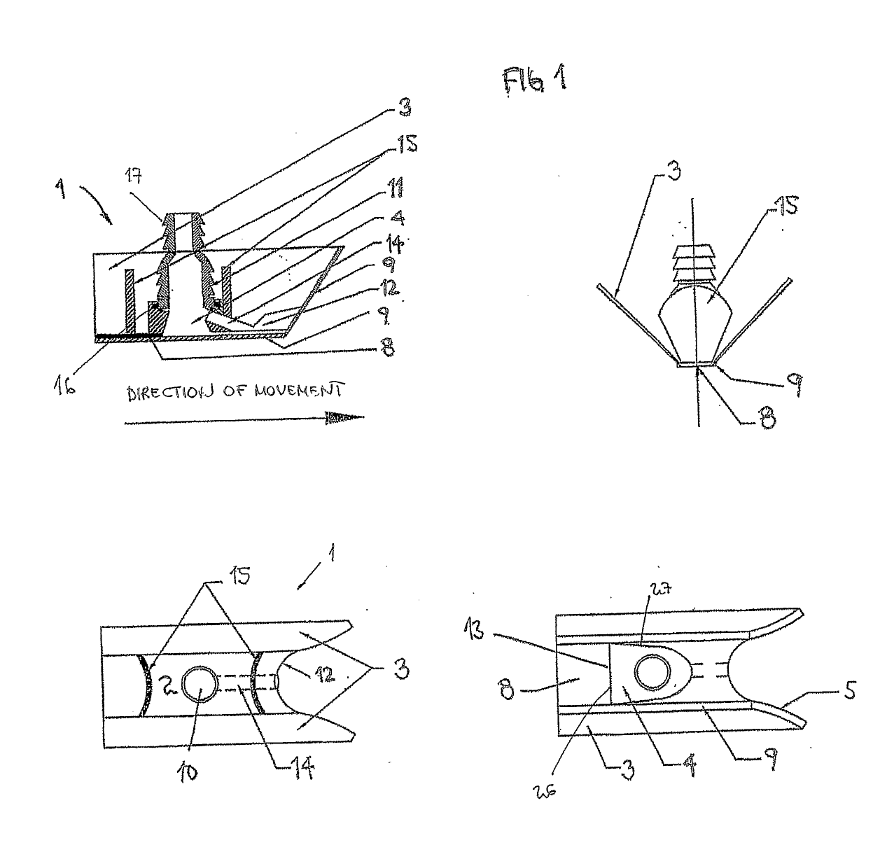

FIG. 1 shows a cross-section of an adapter according to a first embodiment of the invention, from above and under and also from behind.

As can be seen from the figure, the adapter in this embodiment is used in order to apply a pasty agent between two surfaces 21 that are arranged normal to each other. This may for instance be the case when applying a silicone paste, a grouting or the like to corners in a bathroom (floor/walls, walls/ceiling etc.).

The adapter 1 according to the invention can be put on an ordinary grout cartridge (not shown) or it can be connected to the grout cartridge via a flexible hose.

The adapter 1 comprises a body 2, where one or more support wings 3 that are to stabilise the adapter 1 during the grouting, the pasting etc. are arranged on the body 2.

The support wings 3 are arranged so that they are laying against the surfaces that are to be grouted or pasted and following these. In the body 2 is further arranged a pressure magazine or chamber 4 for accumulation of excess substance. The pressure chamber or magazine 4 shall build up a “pressure” in the grouting, in such a way that the grouting will be laid with correct pressure in the joint, groove, seam etc. The pressure chamber 4 will also result in that sufficient grouting is supplied, to ensure that there will be no cavities in the grouting that is laid (the density of the grouting shall be most possible constant).

In FIG. 1 the form of the pressure chamber or magazine 4 is made from a straight, traverse, when seen in relation to the laying direction of the adapter 1, rear edge 26 and from this rear edge 26 two lateral edges 27 which are curved and narrowing towards a foremost edge of the pressure chamber 4.

The pressure chamber or magazine 4 may have other forms also, for instance circular, quadratic etc. A skilled person will know how the pressure chamber 4 shall be designed in order to obtain the wished pressure build up effect.

The pressure chamber 4 is further designed with a thorough aperture 10, where this aperture 10 is utilised to connect the adapter 1 with a grout cartridge or a nozzle. The thorough aperture 10 is on its end that is turning away from the surfaces that are treated, when the adapter is placed against the surfaces, equipped with a connection muff 11. The connection muff 11 connects the adapter 1 in a safe way with either a grouting cartridge, a nozzle or a flexible hose. The connecting muff 11 is further connected to the adapter by means of outwardly pointing elements 16, where these can be pressed in, screwed in etc. in a complementary to the outwardly pointing elements 16 designed locking means (not shown) on the adapter 1.

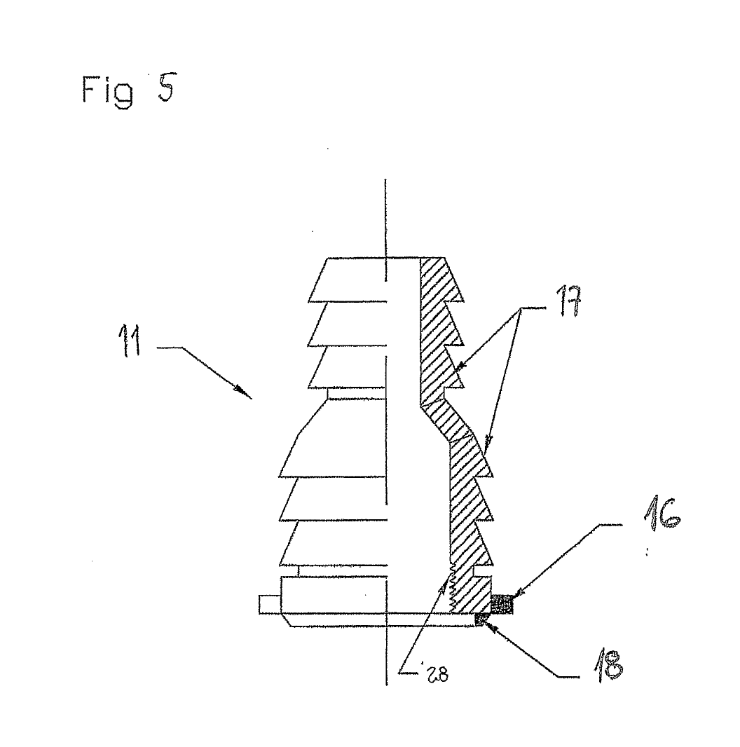

The connection muff 11 shall now be explained in detail, then with reference to FIG. 5.

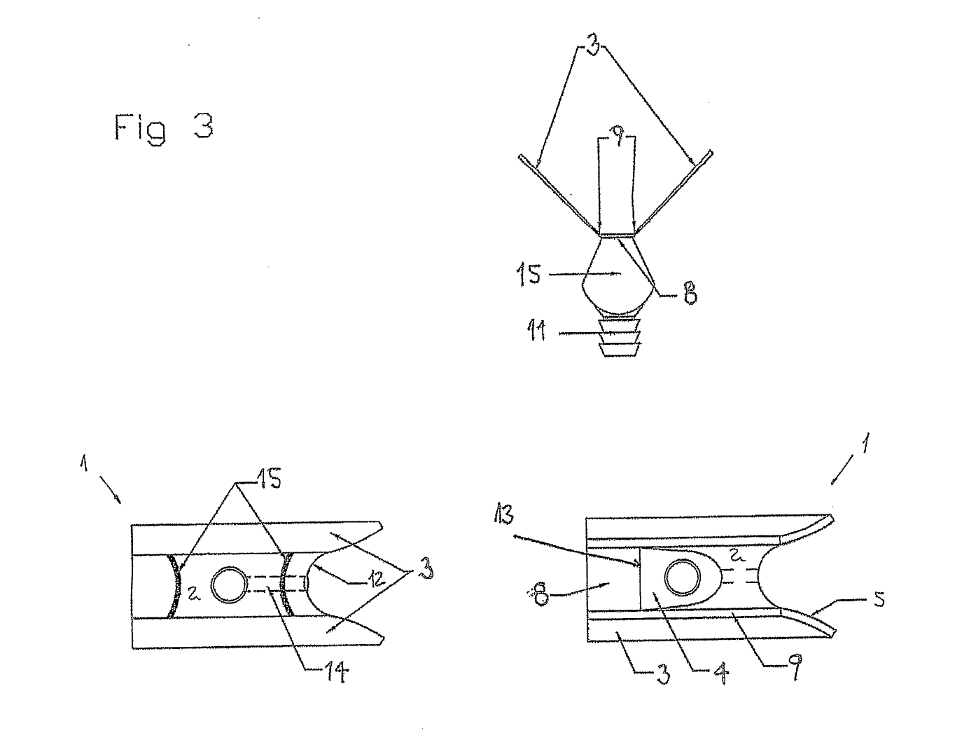

The support wings 3 in FIG. 3 are designed with a larger angle between the wings than the perpendicular surfaces, as this design will result in that the adapter 1 when it is to be used, must be pressed in toward the surfaces, whereby the support wings 3 due to their flexible features are bent inwards to each other. This will prevent the adapter 1, because the support wings 3 are under tension, from wobbling sideways.

The adapter 1 in FIG. 1 is a separate unit, where it is imagined that the adapter 1 is to be connected to a grouting or adhesive cartridge directly or also that it can be connected to a grouting or adhesive cartridge via a nozzle that usually is supplied with purchase of the grouting or adhesive cartridge. It may also nevertheless be imagined that the adapter 1 in an alternative embodiment is made by the nozzle being integrated in adapter 1 itself.

The adapter 1 is basically imagined to be used attached to an ordinary grouting cartridge. However, one may also use the adapter 1 as a separate unit in connection with any type of grouting work.

It might also be imagined that the grouting cartridge and the adapter 1 can be connected through a flexible hose with a certain length, as this will give a more flexible solution when inaccessible and narrow spaces shall be worked (grouted, pasted etc.). This may for instance be preferred when the edge between a wall and a tube shall be grouted, pasted or be similarly treated. The user will then have the adapter 1 in his one hand, while the caulking gun with the grouting cartridge will be placed in the user's other hand. This will allow the adapter 1 without problems can be lead around the whole of the tube.

A joint former 8, where it in addition to creating the form of the laid grouting also shall exercise pressure down against the joint, to ensure that the grouting is pressed in to the joint, groove or the area that is to be grouted. The joint former 8 may have any form or profile, for example a V form, 45 degrees form, 90 degrees form, concave, convex, profiled etc.

At the foremost edge of the adapter 1, i.e. the edge that first is lead in the laying direction of the grouting, there is arranged a recess 12. The purpose of this recess 12, where it in this case is a V form, will be to collect excess grouting and to guide this grouting in towards the pressure chamber or magazine 4. This is achieved by the distance between the front edge of the pressure chamber or magazine 4 and the surfaces that are to be grouted or pasted, when the adapter is laying against these surfaces, being larger than the distance between the rear edge of the pressure chamber or magazine 4 and the surfaces that are to be grouted or pasted, as there here will not be a clearance (the rear edge and the surfaces are in contact with each other). In this case the rear edge is the joint former 8, where the profile of the joint former 8 is plane. The purpose is to create a stop edge 13 at the rear part of the adapter 1, to ensure that the excess is stopped here. On each side of the recess 12 cleaning wings 5 are arranged. The cleaning wings 5 shall collect excess grouting on surfaces 21 that are to be treated and the joint(s) or the groove(s) that the adapter is laying against and to “push” the grouting or the adhesive in against the pressure chamber or magazine 4. The cleaning wings 5 are made from a material that is flexible, but yet so stiff that the desired purpose with the cleaning of the surfaces 21 is obtained.

A sealing membrane 9 is arranged on the underside of the adapter 1, i.e. the side that is laying down to or against the base that is to be grouted or pasted, where the membrane 9 is arranged on both sides of the pressure chamber or magazine 4. The sealing membrane 9 will stretch over the entire longitudinal direction of the adapter 1, and shall prevent the grouting from leaking sideways of the adapter 1.

An amount adjustment tube 14 connects the recess 12 and thorough aperture 10, in such a way that when the adapter is used, the excess grouting due to the V form of the recess be collected and pushed in against the pressure chamber or magazine 4 again. With sufficient pressure in the pressure chamber or magazine 4 the amount adjustment tube 14 will allow the grouting to be guided out of this and towards the joint.

In an alternative design of the adapter 1 is made without an amount adjustment tube 14.

Holding means 15 are arranged at the front and rear edge of the adapter 1, as this allows the adapter 1 to be used as a separate unit. The user will then by means of the holding means 15 use the adapter 1 to form a joint that is of a high quality.

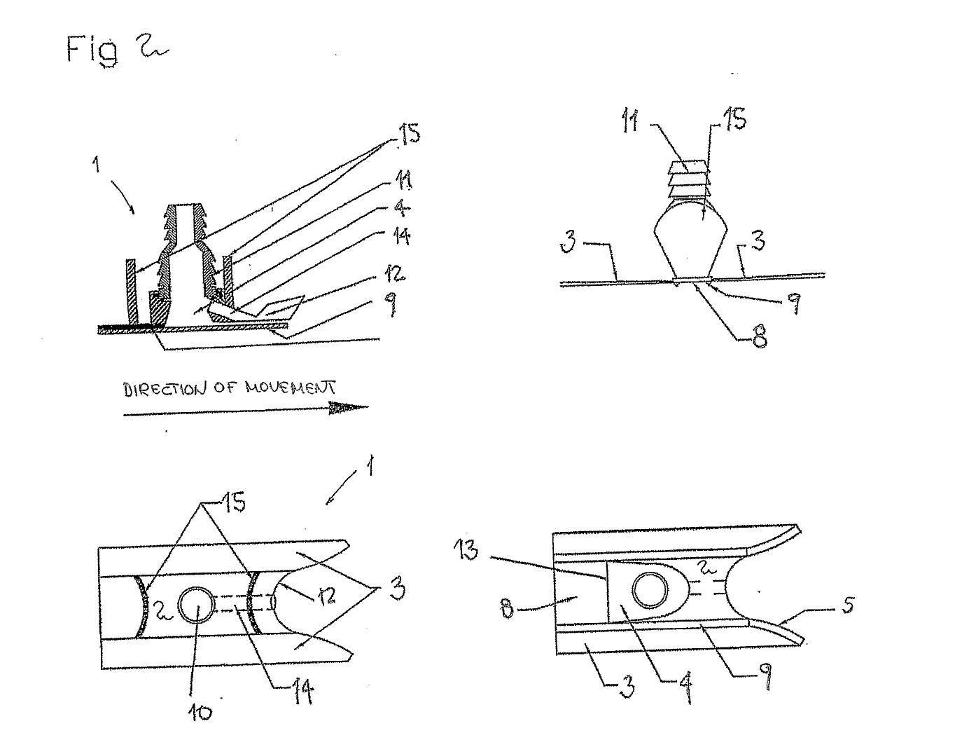

FIG. 2 shows another embodiment of the adapter 1 according to the invention as the adapter 1 now is used to lay a joint between two surfaces 21 that are laying in a same level. The support wings 3 that are accomodating a stabilising of the adapter 1 will here be arranged to follow the surfaces that are to be joined. The adapter 1 will beyond that be approximately equal to the adapter 1 that is shown in FIG. 1.

It may also be imagined that the surfaces 21 that are to be grouted or pasted are horizontal, but misaligned in relation to each other (there is a level difference between them). Then the support wings 3 will in a similar way be misaligned in relation to each other, so that they in this way follow the surfaces in order to stabilise the adapter 1.

A further embodiment of the adapter 1 according to the invention is shown in FIG. 3, where the adapter 1 now is used in connection with the grouting of an external corner that is made of two perpendicular surfaces 21. Here the support wings 3 will be designed on opposite sides of the connecting muff 11.

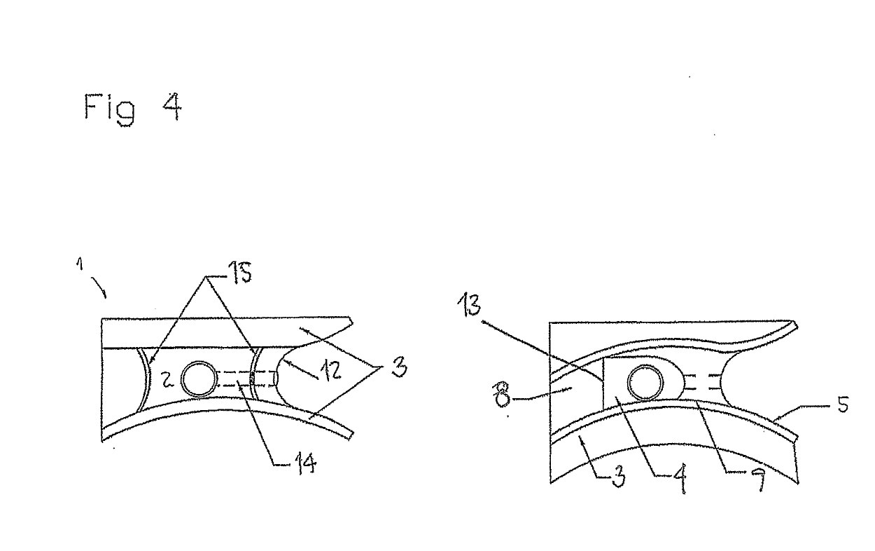

FIG. 4 shows a particular embodiment of the adapter 1 according to the invention, where the adapter 1 is used in connection with laying of a joint or adhesive around a tube, where this tube is perpendicular to a horizontal surface. Here the support wing 3 that is laying against the tube is curved, in such a way that it can follow the tube. The other support wing 3 will be formed to follow the horizontal surface. If the adapter 1 is seen from below, it will be seen that the lower edges of the support wings 3 that are laying against the tube and the surfaces will be curved, to ensure that joint that is laid will follow the edge of the tube. The sealing membrane 9 will be arranged to follow the form of the support wings 3.

The connection muff 11 that is used in connection with the adapter 1 is shown in greater detail in FIG. 5. Here it is seen that the connection muff 11 at its end that is to be connected with the adapter 1, is equipped with two or more vertical outwardly pointing elements 16, where these are to be fastened to complementary notches in the adapter 1 (not shown). This results in that the connection muff 11 may be coupled on and off the adapter 1. How this coupling is achieved will be apparent for a skilled person.

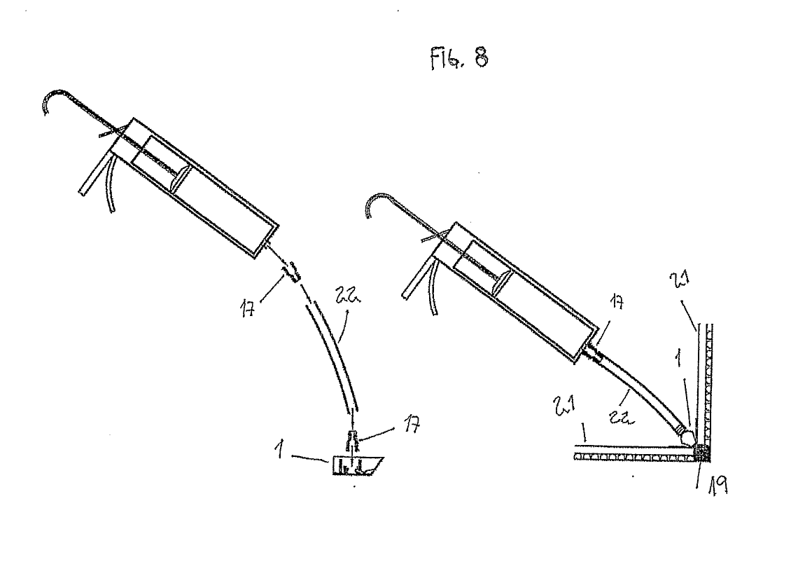

The connection muff 11 is in its edge area on its inside provided with a section of threads 28. These may be used for instance when the connection muff 11 is to be connected to a grouting cartridge directly, see also FIG. 8.

Furthermore, the connection muff 11 will over parts of its longitudinal direction be designed with threads or receptors 17, where the upper part of the connection muff 11 is provided with threads 17 of smaller diameter. If for instance the connection muff is connected to a flexible hose that has larger diameter than the threads 17 at the upper part of the connection muff 11, the flexible hose can be guided over and past this part and down on the threads 17 with larger diameter or the upper part may be cut away.

The connection muff 11 is at its edge that is laying against the adapter 1 provided with a sealing 18, that prevents the grouting or adhesive from leaking out between the adapter 1 and the connecting muff 11.

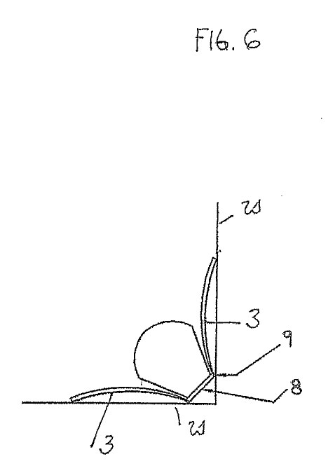

An alternative embodiment of the adapter 1 is shown in FIG. 6, where the adapter 1 is used to lay a joint between two surfaces 21 that are arranged perpendicular to each other. Here the support wings 3 of the adapter 1 will be curved, to ensure that they lie with a press against the surfaces 21. In use adapter 1 must be pushed in to its correct laying position, where the design of the support wings 3 will ensure that the adapter 1 is used correctly.

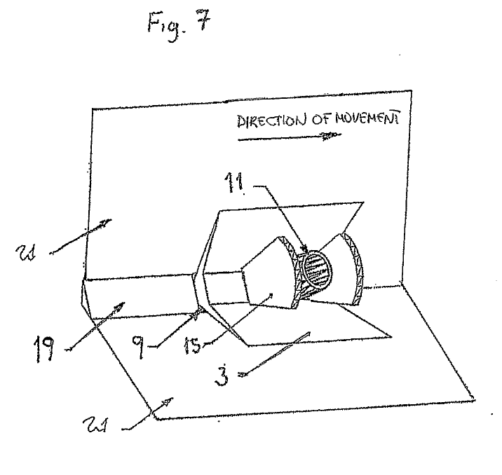

In FIG. 7 an adapter 1 in use is shown, where a joint 19 is laid on the inside of two surfaces 21 forming a 90 degrees angle with each other. An arrow indicates the direction of movement of the adapter 1. Here the support wings 3 lay against each of the surfaces and thus accomodate a stabilisation of the adapter 1. Adapter 1 is not connected to a grout or adhesive cartridge, but may be connected to these by means of the connection muff 11.

FIG. 8 shows an adapter 1 that is connected to a grouting cartridge through a flexible hose 22. The grouting cartridge is arranged in an ordinary caulking gun. By using two connecting muffs 11, a connecting muff 11 between the flexible hose 22 and the outlet tap of the grouting cartridge and a connecting muff 11 between the flexible hose 22 and the adapter 1, it is achieved a greater flexibility for use of the adapter 1, as it is allowed a greater freedom of movement for the caulking gun without the adapter 1 moving out of its correct position. The joint 19 is thereby laid correctly in the joint between the two surfaces 21.

The invention is now explained with one non-limiting embodiment. A skilled person will understand that one will be able to perform many variations and modifications of the devices as described within the scope of the invention as it is defined in the attached claims.

1. An adapter to apply a pasty agent between two adjacent surface parts, comprising a body, one or more support wings and a joint former, adapted to come in contact with a surface that is to be processed, wherein the adapter further comprises a pressure chamber for collection of excess agent and a through aperture that stretches from the inside of the pressure chamber to the outer surface of the adapter, a tube for amount adjustment that connects a recess and the through aperture, and a sealing membrane that stretches on both sides and along the underside of the adapter.

2. Adapter according to claim 1, wherein the sealing membrane is manufactured from a flexible material.

3. Adapter according to claim 1, wherein a connecting muff by means of outwardly pointing elements can be connected to the adapter.

4. Adapter according to claim 1, wherein the connecting muff over a part of or over whole of its length is provided with screws (receivers) of different form or size.

5. Adapter according to claim 1, wherein the sealing membrane has a profile in form of a V form, 45 degrees form, 90 degrees form, concave, convex etc.

6. Adapter according to claim 1, wherein holding means is arranged at the front and rear area of the adapter.

7. Adapter according to claim 1, wherein the profile of the joint former creates the form of the joint and maintains the pressure in the pressure chamber.

8. Adapter according to claim 1, wherein the support wings are manufactured from a partly resilient material.

9. Adapter according to claim 1, wherein a rear edge of the adapter is designed to be a stop edge.

10. Adapter according to claim 1, wherein one or more cleaning wings are arranged on the side of the adapter that is adapted to come in contact with surfaces, inclining towards the pressure chamber.

11. Adapter according to claim 1, wherein the tube for amount adjustment is arranged inclined up from the side of the adapter that is adapted to come in contact with the surfaces.

12. Adapter according to claim 1, wherein the support wings is designed as straight, curved or angled surfaces.

13. Adapter according to claim 1, wherein the support wings form an angle with the adapter, where the angle is stretching from 0 to 360 degrees.
